(19) United States
(12) Patent Application Publication
(10) Pub. No.: US 2017/0075524 A1
(43) Pub. Date: Mar. 16, 2017

(54) Method And Apparatus Of Switching Interfaces

(71) Applicant: Tencent Technology (Shenzhen) Company Limited, Shenzhen (CN)

(72) Inventor: Wen ZHA, Shenzhen (CN)

(21) Appl. No.: 15/359,672

(22) Filed: Nov. 23, 2016

Related U.S. Application Data
(63) Continuation of application No. PCT/CN2014/095601, filed on Dec. 30, 2014.

(30) Foreign Application Priority Data
Jul. 2, 2014 (CN) 201410313158.4

(51) Int. Cl. G06F 3/0482; G06F 3/0481

(52) U.S. Cl. CPC G06F 3/0482; G06F 3/04817

(57) ABSTRACT

A method of switching interfaces comprises a computer having one or more processors and memory storing programs for execution by the one or more processors. The method includes receiving a switching instruction to switch from a current interface and acquiring a sequence of switchable interfaces. The method also includes displaying the sequence of switchable interfaces on a screen and receiving a selecting instruction to select a target interface from the sequence of switchable interfaces. The method also includes switching from the current interface to the target interface and displaying the target interface on the screen.

### CROSS-REFERENCE TO RELATED APPLICATIONS

This application is a continuation of International Application No. PCT/CN2014/095601, filed on Dec. 30, 2014. This application claims the benefit and priority of Chinese Patent Application No. 201410313158.4, filed on Jul. 2, 2014. The entire disclosures of each of the above applications are incorporated herein by reference.

### FIELD

The present application relates to the field of computer technologies, and to a method and system of switching interfaces.

### BACKGROUND

This section provides background information related to the present disclosure which is not necessarily prior art.

A smart phone application comprises hierarchical display interfaces. To reach a further layer of display interface, a user has to traverse multiple interfaces in accordance with the operation procedures. According to one current method of switching interfaces, the user cannot switch directly to a target interface without going through the interfaces corresponding to the operation procedures. For example, as shown in FIG. 1, the operation procedure displays a function homepage, a list interface, a conversation interface, and a search interface sequentially. When the user wants to return from the conversation interface to the function homepage, the user has to go through the search interface and the list interface to switch back to the function homepage. The user cannot switch directly to the function homepage in one step. Thus, the current method of switching interfaces is not flexible and efficient.

The present application provides a method and an apparatus of switching interfaces in a smart phone application, such that the user can switch directly to any target interface in one action with no necessity to follow the operation procedures, and therefore improves the efficiency of interactions between the user and the application.

### SUMMARY

This section provides a general summary of the disclosure, and is not a comprehensive disclosure of its full scope or all of its features.

In accordance with various embodiments, a method of illustrating audio signal strength comprises a portable computer device having one or more processors and memory storing programs executed by the one or more processors, collecting an audio signal using the portable computer device, determining strength of the collected audio signal, determining an illustrative scale that corresponds to the audio signal strength using a mapping function, and superimposing the audio signal strength with the illustrative scale on a graphic area, wherein the graphic area includes an initial sub-area.

According to various embodiments, the method of switching interfaces further comprises storing a sequence of operation interfaces corresponding to a plurality of operation procedures in an order of the operation procedures.

According to various embodiments, the method of switching interfaces further comprises acquiring the sequence of operation interfaces and setting the sequence of operation interfaces as the sequence of switchable interfaces.

According to various embodiments, the method of switching interfaces further comprises storing a sequence of display interfaces prior to the current interface in order; and setting the sequence of display interfaces prior to the current interface as the sequence of switchable interfaces.

According to various embodiments, the method of switching interfaces further comprises, when the switching instruction, returning to a previous interface and displaying the sequence of switchable interfaces on the screen in a reversed order.

According to various embodiments, the switchable interfaces are displayed on the screen in thumbnails, icons, or serial numbers.

According to various embodiments, the method of switching interfaces further comprises setting the target interface as the current interface.

In accordance with various embodiments of the present disclosure, a system of switching interfaces comprises one or more processors, memory, and one or more programs stored in the memory and configured for execution by the one or more processors, The one or more programs include instructions for receiving a switching instruction to switch from a current interface, acquiring a sequence of switchable interfaces, displaying the sequence of switchable interfaces on a screen, receiving a selecting instruction to select a target interface from the sequence of switchable interfaces, switching from the current interface to the target interface, and displaying the target interface on the screen.

In accordance with various embodiments of the present disclosure, a non-transitory computer readable storage medium, storing one or more programs for execution by one or more processors of a service processing system, includes instructions for receiving a switching instruction to switch from a current interface, acquiring a sequence of switchable interfaces, displaying the sequence of switchable interfaces on a screen, receiving a selecting instruction to select a target interface from the sequence of switchable interfaces, switching from the current interface to the target interface, and displaying the target interface on the screen.

Further areas of applicability will become apparent from the description provided herein. The description and various examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The aforementioned implementation of the present disclosure, as well as additional implementations, will be more clearly understood as a result of the following detailed description of the various aspects of the present disclosure when considered in conjunction with the drawings. Like reference numerals refer to corresponding parts throughout the several views of the drawings.

To illustrate the various embodiments more clearly, accompanying drawings to describe the various embodiments are briefly introduced in the following paragraphs. The accompanying drawings in the following description are merely various embodiments of the present disclosure, and persons of ordinary skill in the art may further obtain other drawings according to these accompanying drawings without creative efforts.

FIG. 1 illustrates a method to switch interfaces using the current technology;

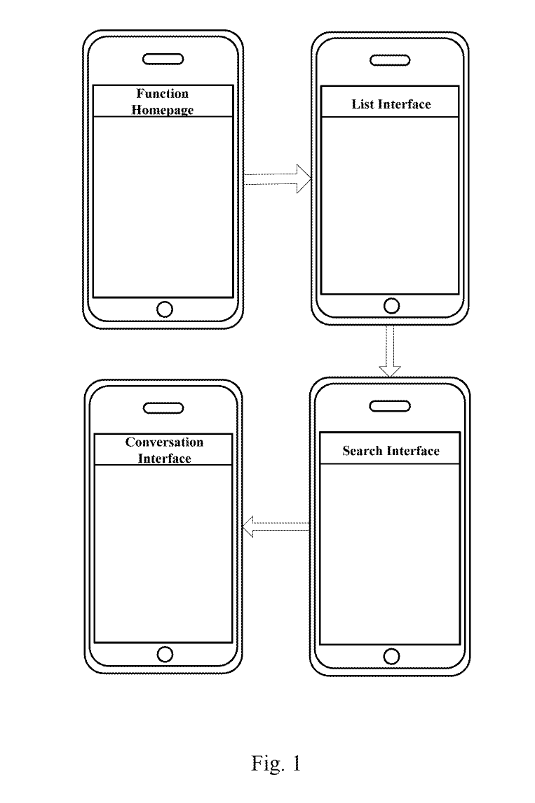

FIG. 2 is a flowchart of a method of switching interfaces according to various embodiments;

FIG. 3 illustrates a method of switching interfaces according to various embodiments;

FIG. 4A is a flowchart of a method of switching interfaces according to various embodiments;

FIG. 4B is a flowchart of a method of switching interfaces according to various embodiments;

FIG. 5 depicts a block diagram of an apparatus of switching interfaces according to various embodiments;

FIG. 6 depicts a block diagram of an apparatus of switching interfaces according to various embodiments; and

FIG. 7 depicts a block diagram of a system of switching interfaces according to various embodiments.

Corresponding reference numerals indicate corresponding parts throughout the several views of the drawings.

### DETAILED DESCRIPTION

Example embodiments will now be described more fully with reference to the accompanying drawings.

The technical methods in the embodiments of the present disclosure are clearly and completely described in the following with reference to the accompanying drawings. The embodiments described are merely part of rather than all of the embodiments of the present disclosure. All other embodiments obtained by persons of ordinary skill in the art based on the embodiments of the present disclosure without creative efforts shall fall within the protection scope of the present disclosure.

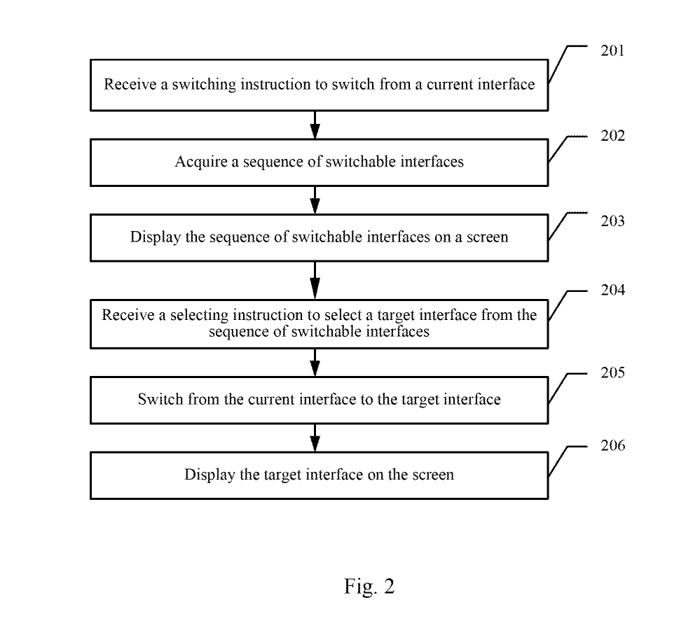

FIG. 2 is a flowchart of a method of switching interfaces according to various embodiments of the present disclosure. The method of switching interfaces according to the various embodiments may comprise the blocks discussed below.

Block 201: A switching instruction to switch from a current interface is received from the user. In a smart phone, a switch instruction may map to an instruction to process an event or a procedure. In the present disclosure, for example, the switch instruction may map an instruction to display a target interface.

Block 202: A sequence of switchable interfaces is acquired. The smart phone may acquire the switchable interfaces that the current interface can switch to, and provide a sequence of switchable interfaces. In various embodiments, the sequence of switchable interfaces may be in the order of the corresponding procedures.

In various embodiments, a sequence of operation interfaces corresponding to a plurality of operation procedures may be stored in the smart phone in an order of the operation procedures, and set as the sequence of switchable interfaces. In various embodiments, a sequence of display interfaces prior to the current interface in order may be stored in the smart phone, and set as the sequence of switchable interfaces. In various embodiments, the sequence of switchable interfaces may include a current interface, an initial or home interface, and all interfaces prior to the current interface until the initial or home interface. The initial or home interface may be a start interface of a smart phone application, a system desktop after turning on the smart phone, or self-defined by the user. In various embodiments, the sequence of switchable interfaces may include a pre-set number of interfaces for the user to select. For example, an operation procedure in a smart phone application may include dozens of switchable interfaces. The smart phone may acquire only ten interfaces, including the target interface that the user selects. The ten interfaces may be closest to the current interface, or may include more function controlling modules.

Block 203: The sequence of switchable interfaces is displayed on a screen. In various embodiments, the switchable interfaces are displayed on the screen in thumbnails. The thumbnails of the switchable interfaces may be adjusted proportionally to the screen size, the display location, the numbers of the switchable interfaces, and other factors, and is recognizable on the screen. In various other embodiments, the switchable interfaces may be displayed on the screen in icons, serial numbers, or other formats that can represent the switchable interfaces.

In various other embodiments, when the switching instruction is a backward instruction, the sequence of switchable interfaces is displayed on the screen in a reversed order, and when the switching instruction is a forward instruction, the sequence of switchable interfaces is displayed on the screen in forwarding order.

According to the present disclosure, the ordering of the switchable interfaces may comply with any user-defined rules, and is not limited to the foregoing examples.

Block 204: A selection instruction to select a target interface from the sequence of switchable interfaces is received from the user. The user may select the target interface from the touch screen of a smart phone.

Block 205: The current interface is switched to the target interface. Upon receiving the selecting instruction, the smart phone may load the page data of the target interface, or launch the screenshot of the target interface.

Block 206: The target interface is displayed on the screen as the current interface. The target interface is now set as the current interface. The prior current interface may be hidden or destroyed. For example, the prior current interface may be temporarily closed for displaying, but the page data may be stored in the smart phone. When the prior current interface is selected to switch to, the smart phone may load the page data and display the prior current interface on the screen. In various other embodiments, the smart phone may exit the prior current interface, and discard the page data.

In various embodiments, the smart phone may determine whether to hide or destroy the current interface based on the type of the displayed interface. When the displayed interface includes information of security or privacy, such as a log in password, user profile, or online banking that cannot be repeatedly submitted, the smart phone may exit the current interface and destroy the page data. Further, when the displayed interface is a general interaction interface, such as user listing of an instant communication application, message list, etc., the smart phone may hide the current interface, and store the page data for later use.

In various embodiments, the smart phone may provide a switching control function, such that the user may switch directly to a key interface. The key interface may be automatically configured by the smart phone based on the user operation pattern. For example, the smart phone may set a most frequently operated interface or a most frequently displayed interface as the key interface. Further, the key interface may be manually configured by the user based on various requirements. For example, in instant communication software, the user sets a conversation interface and a reward distribution interface as two key interfaces. When the current interface is a conversation interface, upon receiving a switching instruction, the current interface may be switched directly to the reward distribution interface, and vice versa. Therefore, the efficiency of switching interfaces can be greatly improved.

According to the present disclosure, the user can switch directly to any target interface in one action with no necessity to follow the operation procedures, and therefore improves the efficiency of interactions between the user and the application.

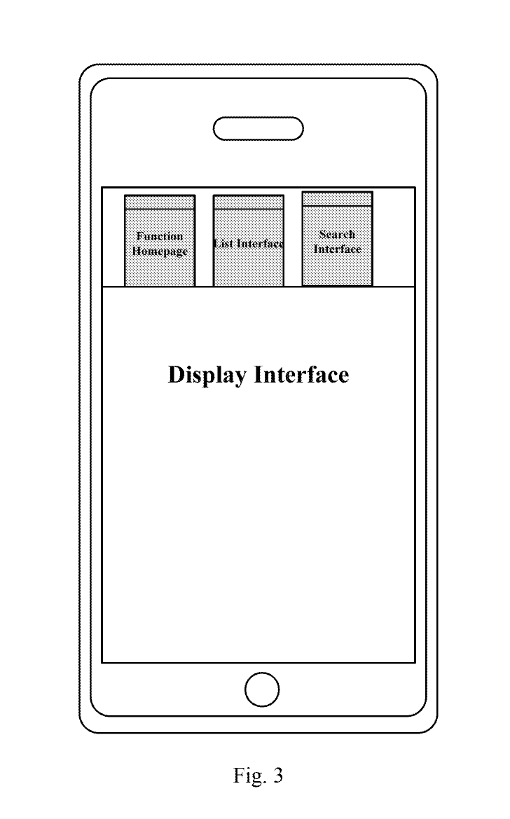

FIG. 3 is an illustration of a method of switching interfaces according to various embodiments of the present disclosure. According to the embodiment shown in FIG. 3, the sequence of switchable interfaces is displayed in thumbnails on top of the current display interface. Further, the thumbnails representing the sequence of switchable interfaces may be displayed on the bottom, the left, or the right side of the current display interface.

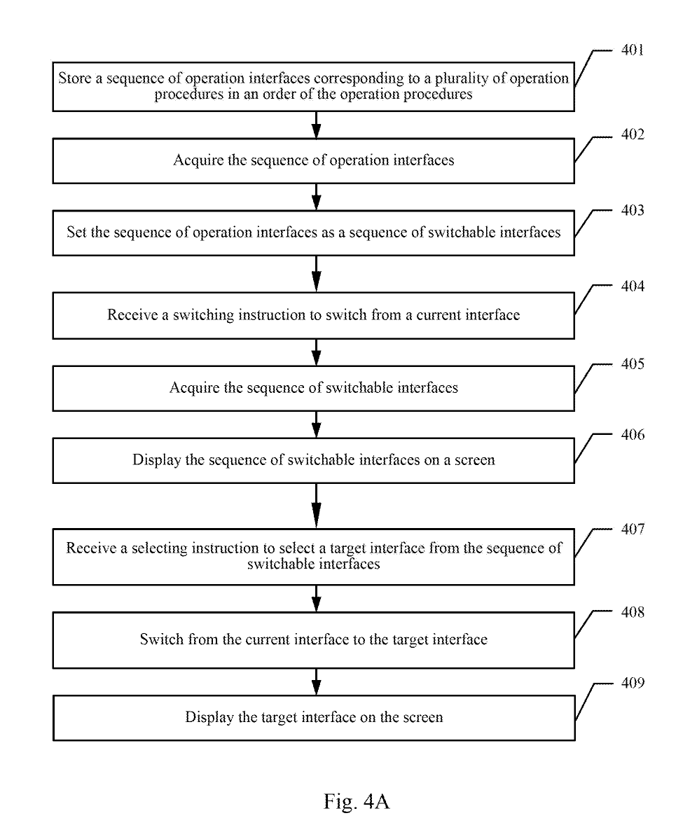

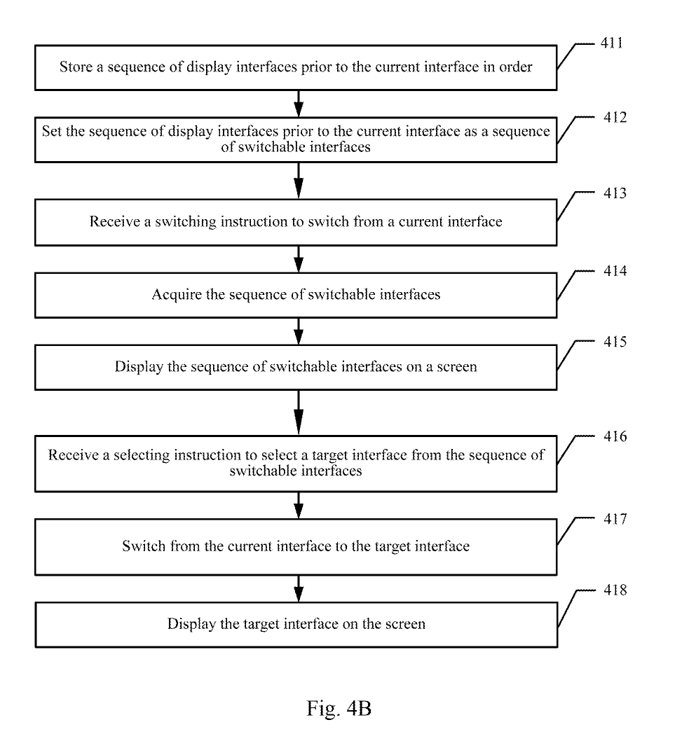

FIG. 4A is a flowchart of a method of switching interfaces according to various embodiments. The method of switching interfaces according to the present embodiment may comprise the blocks discussed below.

Block 401: A sequence of operation interfaces corresponding to a plurality of operation procedures in an order of the operation procedures is stored at the memory. When a plurality of operations is performed, a sequence of interfaces is displayed on the screen corresponding to the plurality of operations. The smart phone may record a screenshot for each interface, and store the screenshots in the order of the operations. Further, when an instruction to switch interfaces is received, the smart phone may load the screenshots directly, and display them on the screen for the user to select from. In various embodiments, the smart phone may record the page date of the interfaces and load the page data directly in response to a switching instruction.

Block 402: The sequence of operation interfaces is acquired.

Block 403: The sequence of operation interfaces is set as the sequence of switchable interfaces.

Block 404: A switching instruction to switch from a current interface is received from the user.

Block 405: A sequence of switchable interfaces is acquired.

Block 406: The sequence of switchable interfaces is displayed on a screen.

Block 407: A selection instruction to select a target interface from the sequence of switchable interfaces is received from the user.

Block 408: The current interface is switched to the target interface.

Block 409: The target interface is displayed on the screen as the current interface.

FIG. 4B is a flowchart of a method of switching interfaces according to various embodiments of the present disclosure. The method of switching interfaces according to the various embodiments may comprise the blocks discussed below.

Block 411: A sequence of display interfaces prior to the current interface is stored in the memory in order. The smart phone may record all display interfaces prior to the current interface that have been reviewed from an initial or home interface. Further, the display interfaces prior to the current interface may be stored according to the displaying order of those interfaces.

Block 412: The sequence of display interfaces prior to the current interface is set as the sequence of switchable interfaces.

Block 413: A switching instruction to switch from a current interface is received from the user.

Block 414: A sequence of switchable interfaces is acquired.

Block 415: The sequence of switchable interfaces is displayed on a screen.

Block 416: A selection instruction to select a target interface from the sequence of switchable interfaces is received from the user.

Block 417: The current interface is switched to the target interface.

Block 418: The target interface is displayed on the screen as the current interface.

According to the present disclosure, the smart phone may generate a sequence of switchable interfaces in a pre-set order, and store page data of the sequence of switchable interfaces. Therefore, the present application can improve the flexibility and efficiency of interface switching.

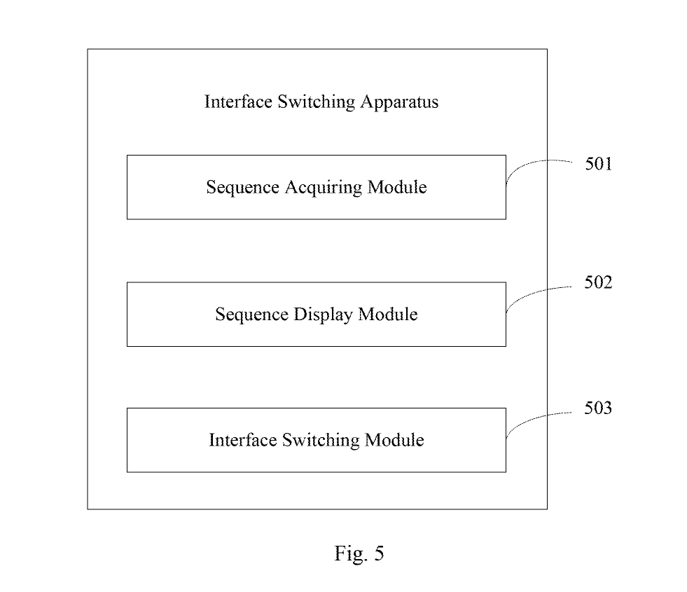

FIG. 5 depicts a block diagram of an apparatus of switching interfaces according to various embodiments of the present disclosure. The apparatus of switching interfaces may include a sequence acquiring module 501 configured to receive a switchable instruction to switch from a current interface and acquire a sequence of switchable interfaces, a sequence display module 502 configured to display the sequence of switchable interfaces on a screen, and an interface switching module 503 configured to receive a selecting instruction to select from a target interface from the sequence of switchable interfaces, and switch from the current interface to the target interface. The interface switching module 503 may be further configured to hide or destroy the current interface, and set the target interface as the current interface. The sequence acquiring module 501, the sequence display module 502, and the interface switching module 503 may be implemented in hardware, firmware, software or any combination thereof.

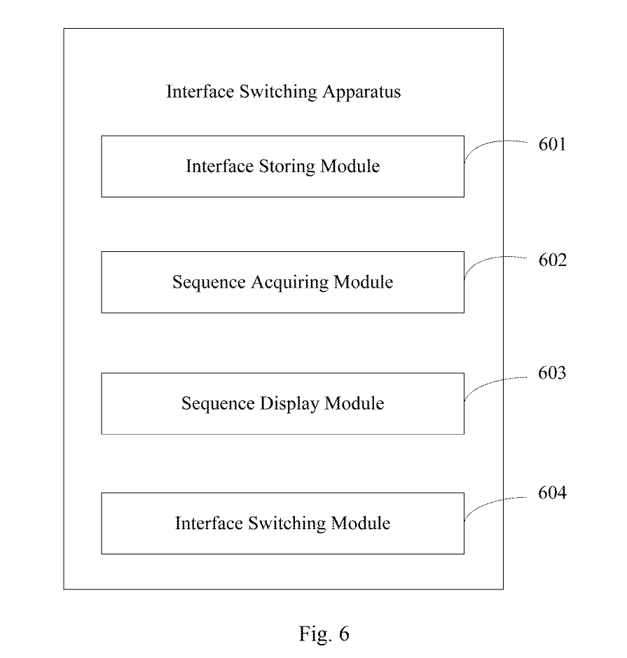

FIG. 6 depicts a block diagram of an apparatus of switching interfaces according to various embodiments of the present disclosure. The apparatus of switching interfaces may include an interface storing module 601 configured to store a sequence of operation interfaces corresponding to a plurality of operation procedures in an order of the operation procedures, and set the sequence of operation interfaces as the sequence of switchable interfaces, a sequence acquiring module 602 configured to acquire a sequence of switchable interfaces, a sequence display module 603 configured to display the sequence of switchable interfaces on a screen, and an interface switching module 604 configured to switch from the current interface to the target interface. The interface storing module 601, the sequence acquiring module 602, the sequence display module 603, and the interface switching module 604 may be implemented in hardware, firmware, software or any combination thereof.

In various embodiments, the interface storing module 601 may be further configured to store a sequence of display interfaces prior to the current interface in order, and set the sequence of operation interfaces as the sequence of switchable interfaces.

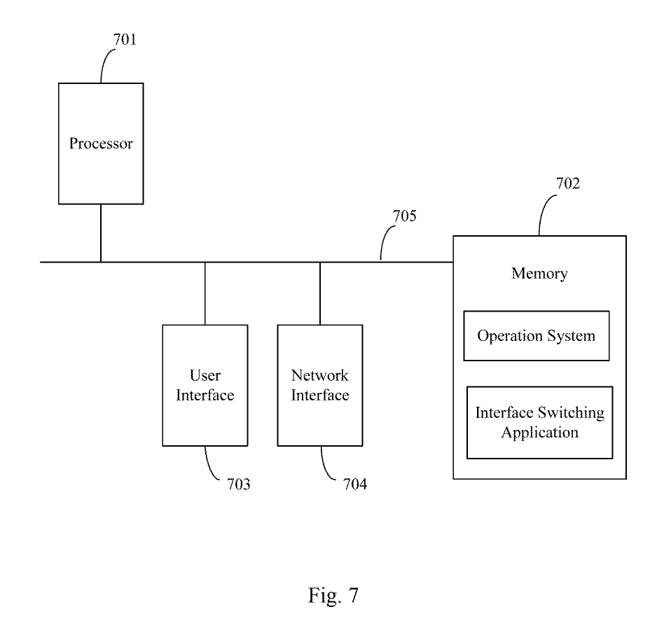

FIG. 7 depicts a block diagram of a system of switching interfaces according to various embodiments of the present disclosure. The system of switching interfaces may include a processor 701, a memory 702, a user interface 703 configured to receive user inputs via touch screen, wired or wireless input devices such as keyboard or mouse, a network interface 704, and a communication bus 705. The network interface 704 may be a wired interface or a wireless interface. The memory 702 may further store one or more programs for execution by one or more processors, such as an operation system, an interface switching application, the page data of the switchable interfaces, the sequence of switchable interface, etc. The one or more programs for execution by one or more processors may include instructions for receiving a switching instruction to switch from a current interface, acquiring a sequence of switchable interfaces, displaying the sequence of switchable interfaces on a screen, receiving a selecting instruction to select a target interface from the sequence of switchable interfaces, switching from the current interface to the target interface, and displaying the target interface on the screen.

According to various embodiments, the one or more programs for execution by one or more processors may further include instructions for storing a sequence of operation interfaces corresponding to a plurality of operation procedures in an order of the operation procedures, acquiring the sequence of operation interfaces, setting the sequence of operation interfaces as the sequence of switchable interfaces, receiving a switching instruction to switch from a current interface, acquiring the sequence of switchable interfaces, displaying the sequence of switchable interfaces on a screen, receiving a selecting instruction to select a target interface from the sequence of switchable interfaces, switching from the current interface to the target interface, and displaying the target interface on the screen.

According to various embodiments, the one or more programs for execution by one or more processors may further include instructions for storing a sequence of display interfaces prior to the current interface in order, setting the sequence of display interfaces prior to the current interface as the sequence of switchable interfaces, receiving a switching instruction to switch from a current interface, acquiring the sequence of switchable interfaces, displaying the sequence of switchable interfaces on the screen, receiving a selecting instruction to select a target interface from the sequence of switchable interfaces, switching from the current interface to the target interface, and displaying the target interface on the screen.

While various embodiments are described above, it should be understood that the present disclosure is not limited to these particular embodiments. On the contrary, the disclosure includes alternatives, modifications, and equivalents that are within the spirit and scope of the appended claims. Numerous details are set forth in order to provide a thorough understanding of the subject matter presented herein. It will be apparent to one of ordinary skill in the art that the subject matter may be practiced without these details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present application. First ranking criteria and second ranking criteria are both ranking criteria, but they are not the same ranking criteria.

The terminology used in the description of the disclosure herein is for the purpose of describing various embodiments and is not intended to limit the disclosure. As used in the description of the disclosure and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or taken out. While some reordering or other groupings are mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to various implementations. However, the illustrative discussions above are not intended to be exhaustive or to limit the disclosure to the precise forms disclosed. Many modifications and variations are possible in view of the above teachings. The implementations were chosen and described in order to best explain principles of the disclosure and its practical applications, to thereby enable others skilled in the art to best utilize the disclosure and various implementations with various modifications as are suited to the particular use contemplated. Implementations include alternatives, modifications and equivalents that are within the spirit and scope of the appended claims. Numerous details are set forth in order to provide a thorough understanding of the subject matter presented herein. It will be apparent to one of ordinary skill in the art that the subject matter may be practiced without these details. In other instances, well-known methods, procedures, components, and circuits have not been described in detail so as not to unnecessarily obscure aspects of the implementations.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A method of switching interfaces comprising:
in a computer having one or more processors and memory storing programs for execution by the one or more processors:
receiving a switching instruction to switch from a current interface;
acquiring a sequence of switchable interfaces;
displaying the sequence of switchable interfaces on a screen;
receiving a selecting instruction to select a target interface from the sequence of switchable interfaces;
switching from the current interface to the target interface; and
displaying the target interface on the screen.

2. The method of switching interfaces according to claim 1, further comprising:
storing a sequence of operation interfaces corresponding to a plurality of operation procedures in an order of the operation procedures.

3. The method of switching interfaces according to claim 2, further comprising:
acquiring the sequence of operation interfaces; and
setting the sequence of operation interfaces as the sequence of switchable interfaces.

4. The method of switching interfaces according to claim 1, further comprising:
storing a sequence of display interfaces prior to the current interface in order; and
setting the sequence of display interfaces prior to the current interface as the sequence of switchable interfaces.

5. The method of switching interfaces according to claim 1, further comprising:
when the switching instruction returns to a previous interface, displaying the sequence of switchable interfaces on the screen in a reversed order.

6. The method of switching interfaces according to claim 1, wherein the switchable interfaces are displayed on the screen in thumbnails, icons, or serial numbers.

7. The method of switching interfaces according to claim 1, further comprising setting the target interface as the current interface.

8. A system of switching interfaces, comprising:
one or more processors;
memory; and
one or more programs stored in the memory and configured for execution by the one or more processors, the one or more programs including instructions for:
receiving a switching instruction to switch from a current interface;
acquiring a sequence of switchable interfaces;
displaying the sequence of switchable interfaces on a screen;
receiving a selecting instruction to select a target interface from the sequence of switchable interfaces;
switching from the current interface to the target interface; and
displaying the target interface on the screen.

9. The system of switching interfaces according to claim 8, wherein the one or more programs further include instructions for:
storing a sequence of operation interfaces corresponding to a plurality of operation procedures in an order of the operation procedures.

10. The system of switching interfaces according to claim 9, wherein the one or more programs further include instructions for:
acquiring the sequence of operation interfaces; and
setting the sequence of operation interfaces as the sequence of switchable interfaces.

11. The system of switching interfaces according to claim 8, wherein the one or more programs further include instructions for:
storing a sequence of display interfaces prior to the current interface in order; and
setting the sequence of display interfaces prior to the current interface as the sequence of switchable interfaces.

12. The system of switching interfaces according to claim 8, wherein the one or more programs further include instructions for:
when the switching instruction returns to a previous interface, displaying the sequence of switchable interfaces on the screen in a reversed order.

13. The system of switching interfaces according to claim 8, wherein the switchable interfaces are displayed on the screen in thumbnails, icons, or serial numbers.

14. The system of switching interfaces according to claim 8, wherein the one or more programs further include instructions for:
setting the target interface as the current interface.

15. A non-transitory computer readable storage medium, storing one or more programs for execution by one or more processors of a service processing system including instructions for:
receiving a switching instruction to switch from a current interface;
acquiring a sequence of switchable interfaces;
displaying the sequence of switchable interfaces on a screen;
receiving a selecting instruction to select a target interface from the sequence of switchable interfaces;
switching from the current interface to the target interface; and
displaying the target interface on the screen.

16. The non-transitory computer readable storage medium according to claim 15, wherein the one or more programs further include instructions for:
storing a sequence of operation interfaces corresponding to a plurality of operation procedures in an order of the operation procedures.

17. The non-transitory computer readable storage medium according to claim 16, wherein the one or more programs further include instructions for:
acquiring the sequence of operation interfaces; and
setting the sequence of operation interfaces as the sequence of switchable interfaces.

18. The non-transitory computer readable storage medium according to claim 15, wherein the one or more programs further include instructions for:
storing a sequence of display interfaces prior to the current interface in order; and
setting the sequence of display interfaces prior to the current interface as the sequence of switchable interfaces.

19. The non-transitory computer readable storage medium according to claim 15, wherein the one or more programs further include instructions for:
when the switching instruction returns to a previous interface, displaying the sequence of switchable interfaces on the screen in a reversed order.

20. The non-transitory computer readable storage medium according to claim 15, wherein the one or more programs further include instructions for:
setting the target interface as the current interface.
